(19) United States
(12) Patent Application Publication
(10) Pub. No.: US 2016/0205482 A1
(43) Pub. Date: Jul. 14, 2016

(54) METHOD AND APPARATUS FOR FITTING A HEARING DEVICE EMPLOYING FREQUENCY TRANSPOSITION

(71) Applicant: Sonova AG, Stafa (CH)

(72) Inventors: Juliane Raether, Mannedorf (CH); Harald Krueger, Affoltern am Albis (CH); Siddhartha Jha, Ruti (CH)

(21) Appl. No.: 14/900,311

(22) PCT Filed: Jun. 28, 2013
(86) PCT No.: PCT/EP2013/063675

§ 371 Date: Dec. 21, 2015

(51) Int. Cl. H04R 25/00

(52) U.S. Cl. CPC H04R 25/558; H04R 25/353; H04R 25/70; H04R 2225/61

(57) ABSTRACT

A method for adjusting a hearing device to hearing preferences of a user. A frequency transposition device is configurable by at least two frequency modification parameters (C_{R}, Fₖ, F_{HL}, W). The method includes manually adjusting at least two control elements each associated with a different one of at least two auditory perceptive dimensions (H, D, V, A), and automatically setting the at least two frequency modification parameters (C_{R}, Fₖ, F_{HL}, W) based on the adjusting of said at least two control elements. An alternative method includes manually adjusting at least one control element associated with one of the at least two frequency modification parameters, and determining based on said adjusting a qualitative prediction value for each of at least two auditory perceptive dimensions. Moreover, corresponding apparatuses for adjusting a hearing device including a frequency transposition device are presented.

### TECHNICAL FIELD OF THE INVENTION

The present invention is related to a method for fitting a hearing device employing frequency transposition as well as to an apparatus capable of performing the method.

### DESCRIPTION OF THE RELATED ART

Various approaches for frequency lowering have been pursued in order that hearing impaired patients with high frequency hearing loss can benefit, especially in those cases where the amplification of the original high frequency sound is not useful—e.g. due to dead regions—or not possible—due to potential feedback problems when applying high gain or due to limited bandwidth of applied gain.

Known teachings describing frequency lowering schemes are for instance disclosed in WO 2007/000161 A1, U.S. Pat. No. 7,248,711 B2, AU 2002300314 A1 and EP 1 686 566 A2. The known teachings have one or several of the following disadvantages:
vowels are distorted for cut-off frequencies below 1′500 Hz;
the known transposition schemes often result in increased confusion for the hearing device user;
distortions of harmonic relationships lead to an altered pitch perception and decrease the pleasure of listening music.

It is therefore desirable to overcome at least one of the above-mentioned disadvantages. In the international application WO 2012/175134 A1 of the present applicant—herewith incorporated by reference—an improved method is proposed for operating a hearing device applying a frequency transposition scheme, whereby signal components of a source region of the input signal spectrum are adaptively selected taking into account current characteristics of the input signal, and the selected signal components are transposed to a destination (also referred to as target) region. As part of the improved method it is for instance further proposed to apply a pre-weighting function to signal components of the source region before adaptively selecting the source region.

In the frequency transposition scheme described in AU 2002300314 A1 only two physical parameters can be adjusted, namely a cut-off frequency and a compression ratio. Fitting methods suitable for adjusting a hearing system applying such a scheme to the hearing preferences of its user are for instance disclosed in EP 1 538 868 A2 as well as in WO 2007/135198 A2. Moreover, EP 2 026 601 A1 discloses another method for configuring a frequency transposition scheme.

However, these known fitting methods demand a considerable level of experience and expertise with adjusting frequency transposition hearing devices from the person charged with performing the process, i.e. a fitter, e.g. a hearing health care professional such as an audiologist or an acoustician. The complexity of the fitting process is further increased when the frequency transposition scheme involves more than two parameters, as is the case with the improved scheme proposed by the present applicant in the international application WO 2012/175134 A1.

It is therefore an object of the present invention to provide an alternative, simpler fitting method for hearing devices employing frequency transposition, which can be performed by a fitter with little experience and limited expertise in dealing with such hearing devices capable of frequency transposition.

### SUMMARY OF THE INVENTION

In the context of the present invention, the term “transposition” or “transpose” is defined as having at least one of the following meanings:
a replacement of destination/target frequency components by source frequency components;
any combination of destination/target frequency components with corresponding source frequency components.

Furthermore, the term “hearing device” is not only directed to hearing aids (also referred to as hearing instruments or hearing prostheses) that are used to improve the hearing of hearing impaired patients but also to any communication device, be it wired or wireless, or to hearing protection devices. Hearing aids may also be implantable, such as direct acoustic cochlear stimulation (DACS) middle ear implants and cochlear implants (CI), or bone anchored hearing aids (BAHA) attached to the skull.

The present invention is first directed to a method for adjusting a hearing device comprising frequency transposition means to hearing preferences of a user of said hearing device, said frequency transposition means being configurable by at least two frequency modification parameters, said method comprising the steps of:
a1) manually adjusting at least two control elements each associated with a different one of at least two auditory perceptive dimensions;
b1) automatically setting said at least two frequency modification parameters based on said adjusting of said at least two control elements.

The present invention also provides an alternative method for adjusting a hearing device comprising frequency transposition means to hearing preferences of a user of said hearing device, said frequency transposition means being configurable by at least two frequency modification parameters, said method comprising the steps of:
a2) manually adjusting at least one control element associated with one of said at least two frequency modification parameters;
b2) determining based on said adjusting a qualitative prediction value for each of at least two auditory perceptive dimensions.

The at least two frequency modification parameters can then be automatically set based on the determined qualitative prediction values, each of which is associated with one of the at least two auditory perceptive dimensions.

In a specific embodiment of the present invention, the alternative method further comprises the step of displaying said qualitative prediction value for at least one of, preferably for each of, said at least two auditory perceptive dimensions, and optionally automatically adjusting a further control element (or further control elements, each one being) associated with one of said at least two auditory perceptive dimensions.

In further embodiments of the present invention, the alternative method further comprises the step of performing an auditory performance test (as defined below) to assess the auditory performance of the user for at least one of the at least two auditory perceptive dimensions, and subsequently repeating steps a2) and b2).

In further embodiments of the present invention, each of said at least two auditory perceptive dimensions is a dimension in which an auditory performance of said user can be influenced by changing said at least two frequency modification parameters.

In further embodiments of the present invention, each of said at least two auditory perceptive dimensions is a dimension for which said user's auditory perception can be or is assessed by means of an auditory performance test, an auditory performance test being a test which allows to compare the auditory performance of two individuals or of two different aided conditions (i.e. using a hearing device) for the same individual.

In further embodiments of the present invention, the method further comprises the step of performing an auditory performance test to assess the auditory performance of the user for at least one of the at least two auditory perceptive dimensions, and subsequently performing or repeating steps a1) and b1), step a1) then being based on the outcome of the auditory performance test.

In further embodiments of the present invention, said auditory perceptive dimension is selected from a group comprising at least two of:
harmonics protection;
distinction;
audibility;
recognition;
vowel information protection.

Thereby, harmonics protection aims at maintaining the relationship between a fundamental tone and its harmonics, such that especially the timbre of a person's voice or of a musical instrument is not noticeably altered. Distinction is for instance related to being able to distinguish between different fricatives, such as the consonants “f”, “s”, “x” and “z”. Audibility generally pertains to providing sufficient audible sound (i.e. frequency range) to an ear drum or sufficient stimulus to a middle ear or cochlear of a person by means of a hearing device (BTE, ITE or implanted), which will depend on the frequency range within which the hearing impaired person can still perceive sounds. Recognition generally relates to providing a sufficient level of sound (i.e. sound pressure level) to an ear drum or sufficient stimulus to a middle ear or cochlear of a person by means of a hearing device (BTE, ITE or implanted), which will depend on the level of hearing loss the person has at different frequencies. Furthermore, vowel information protection is directed to preserving the highest vowel formants, so that a hearing impaired user of a hearing device (BTE, ITE or implanted) is capable of distinguishing between different vowel sounds, such as “a”, “e”, “i”, “o” and “u”.

In further embodiments of the present invention, said audibility pertains to one or more of:
general audibility;
phoneme audibility;
vowel audibility;
consonant audibility, in particular audibility of fricatives such as “s” and “f”;
tone audibility.

In further embodiments of the present invention, said distinction pertains to one or more of:
general distinction;
phoneme distinction;
vowel distinction;
consonant distinction;
word distinction;
musical tone distinction;
musical interval or chord distinction;
timbre distinction.

In further embodiments of the present invention, said recognition pertains to one or more of:
general recognition;
phoneme recognition;
vowel recognition;
consonant recognition;
word recognition;
speech recognition;
musical tone recognition;
musical interval or chord recognition;
timbre recognition.

In further embodiments of the present invention, said group comprises at least a vowel dimension, in particular one or more of:
a general vowel dimension;
a vowel audibility dimension;
a vowel distinction dimension;
a vowel recognition dimension.

In further embodiments of the present invention, said frequency modification parameters comprise at least two of the following:
compression ratio C_{R};
lower cut-off frequency Fₖ;
upper cut-off frequency F_{HL} (being the lowest frequency of a second source stack);
frequency weighting factor W or frequency weighting function w.

The latter may comprise multiple frequency weighting factors Wᵢ for i=1, 2, . . . (e.g. a (multi-)step function) or be a continuous frequency-dependent function w(f).

In further embodiments of the present invention, the lower cut-off frequency Fₖ is 1′500 Hz or less and/or the upper cut-off frequency F_{HL} is 2 kHz or less.

In further embodiments of the present invention, settings of said at least two frequency modification parameters are derived from settings of said at least two control elements by means of a look-up table.

In further embodiments of the present invention, settings of said at least two frequency modification parameters are derived from settings of said at least two control elements by means of interpolation, in particular linear interpolation, particularly between settings of said at least two frequency modification parameters corresponding to extreme settings for each of said at least two control elements, in particular maximum and/or minimum settings of each of said at least two control elements.

In further embodiments of the present invention, settings of said at least two frequency modification parameters are derived from settings of said at least two control elements by means of a weighted sum, the weighting being dependent on the setting of each of said at least two control elements.

Furthermore, the present invention is directed to an apparatus for adjusting a hearing device comprising frequency transposition means to hearing preferences of a user of said hearing device, said frequency transposition means being configurable by at least two frequency modification parameters, said apparatus comprising:
at least two control elements, in particular manually adjustable control elements, each associated with adjusting a different one of at least two auditory perceptive dimensions;
determination means adapted to automatically determine settings of said at least two frequency modification parameters based on settings of said at least two control elements corresponding to target values within the associated auditory perceptive dimension.

The present invention also provides an alternative apparatus for adjusting a hearing device comprising frequency transposition means to hearing preferences of a user of said hearing device, said frequency transposition means being configurable by at least two frequency modification parameters, said apparatus comprising:
at least one control element, in particular a manually adjustable control element, associated with one of said at least two frequency modification parameters;
prediction means for automatically determining a qualitative prediction value for each of at least two auditory perceptive dimensions based on a setting of said at least one control element.

The means for automatically determining a qualitative prediction value for each of the at least two auditory perceptive dimensions may comprise one or more estimators. The one or more estimators determine the qualitative prediction value associated with each auditory perceptive dimension by for instance applying a test signal (e.g. a speech sample or music) to a model of the hearing device having a transfer function, especially a frequency transposition function adaptable by the frequency modification parameters, which is set by the at least one control element. The output signal from the model is then further processed, e.g. according to the audiogram of the hearing impaired user of the hearing device to yield a signal as perceived by the user (i.e. a modelled perceived signal). Subsequently, the qualitative prediction value is derived by an analysis of the modelled perceived signal or a difference between the modelled perceived signal and the test signal. Alternatively, such qualitative prediction values may also be derived from data stored in a database comprising results of (qualitative and/or quantitative) assessments, e.g. of auditory performance tests, performed by hearing impaired persons having various degrees of hearing impairment, the assessment results being provided from tests using various hearing devices with different settings, especially of the frequency modification parameters.

In a specific embodiment the apparatus according to the present invention further comprises presentation means for displaying said qualitative prediction value for at least one of, preferably for each of, said at least two auditory perceptive dimensions.

In further embodiments the apparatus according to the present invention comprises a further control element (or further control elements, each one being) associated with one of said at least two auditory perceptive dimensions and automatically adjustable to one of said qualitative prediction values of one of said at least two auditory perceptive dimensions.

In further embodiments of the apparatus according to the present invention, each of said at least two auditory perceptive dimensions is a dimension in which an auditory performance of said user can be influenced by changing said at least two frequency modification parameters.

In further embodiments of the apparatus according the present invention, each of said at least two auditory perceptive dimensions is a dimension for which said user's auditory perception can be assessed by means of an auditory performance test, an auditory performance test being a test which allows to compare the auditory performance of two individuals or of two different aided conditions for the same individual.

In further embodiments of the apparatus according to the present invention, said perceptive dimension is selected from a group comprising at least two of:
harmonics protection;
distinction;
audibility;
recognition;
vowel information protection.

In further embodiments of the apparatus according to the present invention, said audibility pertains to one or more of: general audibility;
phoneme audibility;
vowel audibility;
consonant audibility, in particular audibility of fricatives such as “s” and “f”;
tone audibility.

In further embodiments of the apparatus according to the present invention, said distinction pertains to one or more of:
general distinction;
phoneme distinction;
vowel distinction;
consonant distinction;
word distinction;
musical tone distinction;
musical interval or chord distinction;
timbre distinction.

In further embodiments of the apparatus according to the present invention, said recognition pertains to one or more of:
general recognition;
phoneme recognition;
vowel recognition;
consonant recognition;
word recognition;
speech recognition;
musical tone recognition;
musical interval or chord recognition;
timbre recognition.

In further embodiments of the apparatus according to the present invention, said group comprises at least a vowel dimension, in particular one or more of:
a general vowel dimension;
a vowel audibility dimension;
a vowel distinction dimension;
a vowel recognition dimension.

In further embodiments of the apparatus according to the present invention, said frequency modification parameters comprise at least two of the following:
compression ratio C_{R};
lower cut-off frequency Fₖ;
upper cut-off frequency F_{HL};
frequency weighting factor W or frequency weighting function w.

In further embodiments of the apparatus according to the present invention, the lower cut-off frequency Fₖ is 1′500 Hz or less and/or the upper cut-off frequency F_{HL} is 2 kHz or less.

In further embodiments the apparatus according to the present invention further comprises a look-up table configured to derive settings of said at least two frequency modification parameters from settings of said at least two control elements.

In further embodiments the apparatus according to the present invention further comprises interpolation means configured to derive settings of said at least two frequency modification parameters from settings of said at least two control elements, in particular configured to perform linear interpolation, particularly configured to perform interpolation between settings of said at least two frequency modification parameters corresponding to extreme settings for each of said at least two control elements, in particular maximum and/or minimum settings of each of said at least two control elements.

In further embodiments the apparatus according to the present invention further comprises weighting means for providing weighted sums configured to derive settings of said at least two frequency modification parameters from settings of said at least two control elements, the weighting being dependent on the setting of each of said at least two control elements.

It is expressly pointed out that the above-mentioned embodiments can be arbitrarily combined to yield further specific embodiments of the method and apparatus according to the present invention.

### BRIEF DESCRIPTION OF THE DRAWINGS

The present invention is further illustrated by way of exemplified embodiments shown in the accompanying drawings and described in detail in the following. It is pointed out that these embodiments are for illustrative purposes only and shall not limit the present invention as set out by the claims.

FIG. 1 shows a block diagram of a hearing device with its main components;

FIG. 2 shows a graph illustrating a known transposition scheme;

FIG. 3 shows a graph illustrating a first embodiment of a recently proposed (known) frequency transposition scheme;

FIG. 4 shows a further graph illustrating a second embodiment of the recently proposed (known) frequency transposition scheme;

FIG. 5 shows yet a further graph illustrating a third embodiment of the recently proposed (known) frequency transposition scheme;

FIG. 6 a) shows a block diagram of an embodiment of a fitting apparatus according to the present invention, and
b) shows a block diagram of an alternative embodiment of a fitting apparatus according to the present invention;

FIG. 7 shows a graph illustrating a first frequency transposition scheme employing exemplary settings of perception based controls according to the present invention;

FIG. 8 shows a further graph illustrating a second frequency transposition scheme employing perception based controls with settings directed to maximising protection of harmonics;

FIG. 9 shows a further graph illustrating a third frequency transposition scheme employing perception based controls with settings directed to maximising distinction;

FIG. 10 shows a further graph illustrating a fourth frequency transposition scheme employing perception based controls with settings directed to maximising vowel preserving; and

FIG. 11 shows a further graph illustrating a fifth frequency transposition scheme employing perception based controls with settings directed to maximising audibility.

In the figures like reference signs refer to like elements.

### DETAILED DESCRIPTION OF THE INVENTION

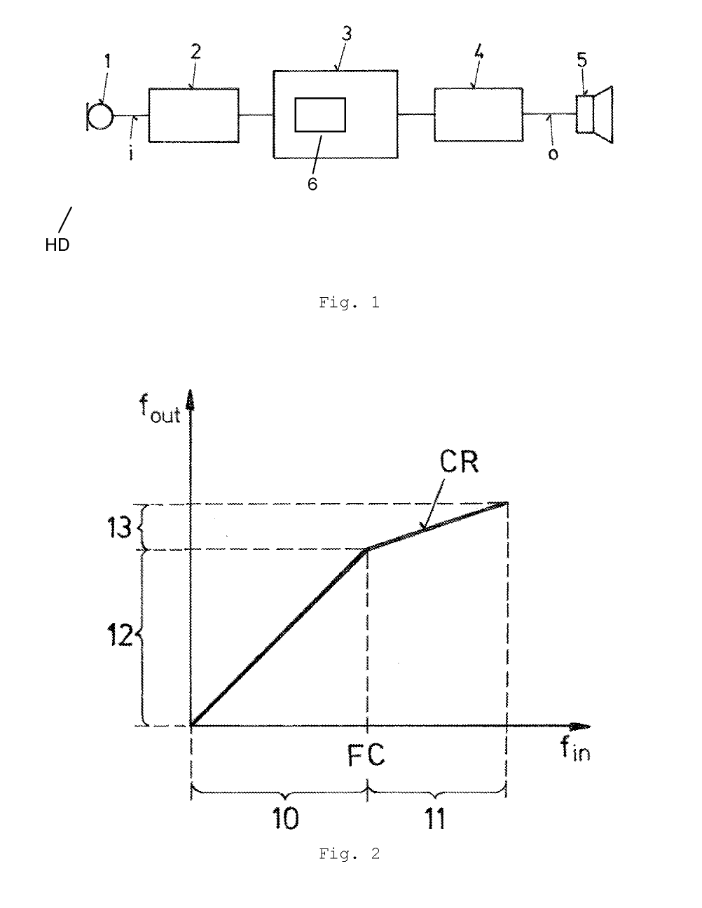

In FIG. 1 a hearing device HD is depicted comprising an input transducer 1, such as a microphone, an analogue-to-digital converter 2, a signal processing unit 3, a digital-to-analogue converter 4 and an output transducer 5, which is also called receiver or loudspeaker. For example, a hearing device HD is used to restore or to improve the hearing of a hearing impaired person in that a sound signal is picked up by the input transducer 1 and converted to an input signal i. In case of a digital hearing device HD, the analogue-to-digital converter 2 generates a corresponding digital input signal that can now be processed by the signal processing unit 3, in which an output signal is calculated taking into account the hearing impairment of the user. This output signal o is fed, in case of the digital hearing device HD via the digital-to-analogue converter 4, to the output transducer 5. The output transducer 5 may for instance be adapted to directly stimulate the ossicles of the middle ear or the cochlear in the inner ear, for instance in the form of a DACS (direct acoustical cochlear stimulation) middle ear implant or a cochlear implant.

In case a signal processing algorithm, which is implemented in the signal processing unit 3, is applied in the frequency domain, a transformation function, such as a Fast Fourier Transformation (FFT), is used to transform the input signal i from the time domain into the frequency domain. Consequently, an inverse transformation function must be applied in order to transform an output spectrum into the time domain after implementing the signal processing algorithm. Instead of a Fourier transformation function and its inverse function, any other transformation function may be implemented, such as a Hadamard, a Paley or Slant transformation.

As part of the signal processing the signal processing unit 3 in particular performs a frequency transposition, which is implemented in the frequency transposition means 6. Within the context of the present invention, the frequency transposition means 6 is configurable by at least two frequency modification parameters. The frequency transposition means 6 is for instance adapted to transpose selected frequency ranges, which are important for the hearing perception of a user of the hearing device HD but in which frequency ranges the user is not able to perceive an acoustic signal due to a complete hearing loss, to another frequency range in which the hearing device user can perceive an acoustic signal.

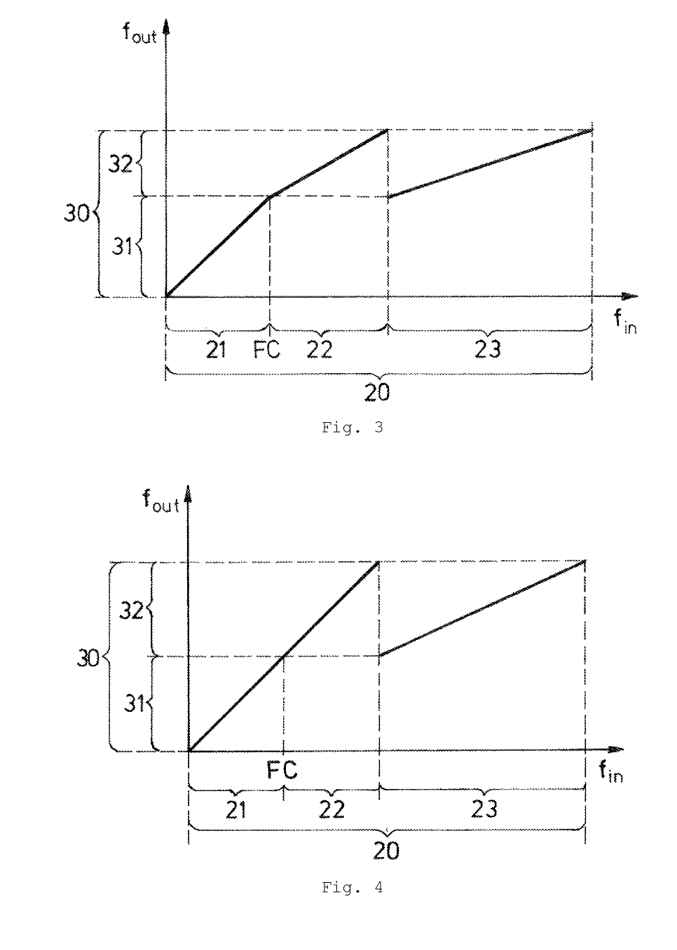

A known approach is to employ a mapping between the input frequencies fᵢₙ and the output frequencies fₒᵤₜ for different spectral regions defined by a cut-off frequency FC and a compression ratio C_{R} as depicted in the graph of FIG. 2, where the input frequency fᵢₙ is shown on the x-axis while the output frequency fₒᵤₜ is shown on the y-axis. While below the cut-off frequency FC no change occurs to the signal, a linear transposition takes place above the cut-off frequency FC dependent on the selected compression ratio C_{R}. One of the main limitations of this non-linear frequency compression algorithm is that the cut-off frequency FC is limited on the lower side to 1500 Hz. This means that the hearing device user having a profound hearing loss above 1500 Hz is not going to benefit from this frequency transposition algorithm. This is because transposing frequency components to lower frequencies than the cut-off frequency FC of 1500 Hz results in distortions of vowels and non-fricative sounds which have a strong format structure in the frequency region below 1500 Hz. The information, which is otherwise available undistorted to the hearing impaired, gets distorted by the known frequency transposition algorithm on lowering the cut-off frequency below 1500 Hz. Such a behaviour is unacceptable as it would be a barrier to initial acceptance of the processed sound by the hearing impaired user who is already used to hearing the vowels in a “close to normal” way.

Furthermore, known frequency transposition algorithms distort the harmonic structure of the input sound. Therefore, it is also not very useful for transposing music where it introduces unpleasant pitch distortions.

In connection with known frequency transposition schemes, it has been pointed out that the cut-off frequency FC must be equal or larger than 1500 Hz in order not to distort vowels and non-fricative sounds which have a strong format structure in a frequency region below 1500 Hz. Therefore, signal components below the cut-off frequency FC are not changed, i.e. a so called lower source region 10 on the x-axis directly corresponds to a lower target region 12 on the y-axis (one-to-one mapping). Above the cut-off frequency FC, a linear transposition is implemented in that signal components of a so called higher source region 11 are transposed to a higher target region 13 that has a smaller bandwidth than the higher source region 11. The known technique does not enable a hearing impaired person to benefit from a frequency lowering algorithm having a cut-off frequency FC below 1500 Hz, while offering acceptable sound quality and minimal distortion of vowels and non-transposed sounds, which are otherwise audible without much distortion.

A new frequency transposition scheme proposed by the present applicant in the international application WO 2012/175134 A1 adaptively selects signal components of a source region taking into account current characteristics of the input signal i.

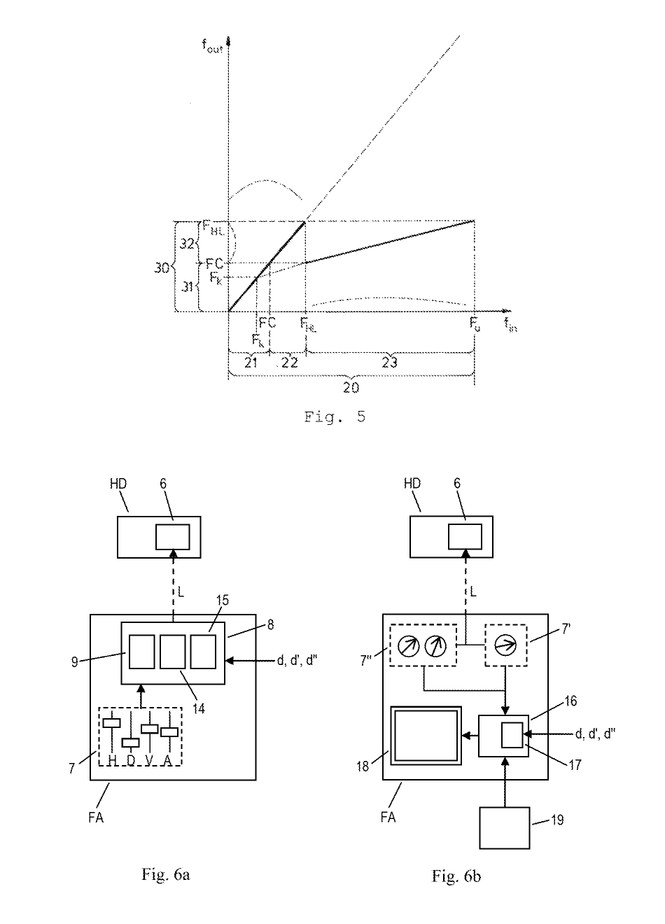

In embodiments of the new frequency transposition scheme, a so called frequency stacking algorithm is implemented. FIG. 3 illustrates a basic concept of the frequency stacking algorithm, where on the horizontal axis of the graph an input frequency fᵢₙ is indicated while an output frequency fₒᵤₜ is indicated on the vertical axis of the graph. A source region 20 comprises a lower source region 21 and two source stacks 22 and 23, the lower source region 21 comprising frequencies up to a cut-off frequency FC, and the two source stacks 22, 23 comprising frequencies above the cut-off frequency FC. The first source stack 22 starts at the cut-off frequency FC, the second source stack 23 immediately follows the first source stack 22. A destination region 30 comprises a lower destination region 31 and a destination stack 32, the lower destination region 31 comprising frequencies up to the cut-off frequency FC, and the destination stack 32 comprising frequencies above the cut-off frequency FC. As can be seen in FIG. 3, the transposition scheme is such that signal components having frequencies in the lower source region 21 are mapped in a one-to-one mapping to the lower destination region 31. Furthermore, signal components having frequencies in the first source stack 22 as well in the second source stack 23 are transposed to the destination stack 32.

If a frequency range of a source region being transposed is equal to a frequency range of a destination region, a mere frequency shifting takes place. If, on the other hand, a frequency range of a source region being transposed is greater than a frequency range of a destination region, a compressive frequency transposition takes place.

FIG. 3 shows compressive transpositions for the transposition of the first source stack 22 to the destination stack 32, as well as for the transposition of the second source stack 23 to the destination stack 32.

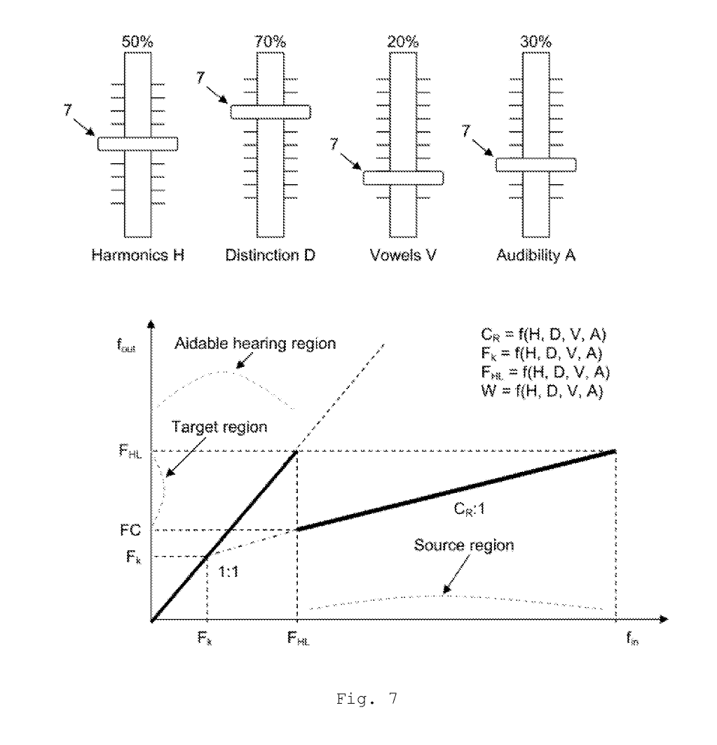

FIG. 4 shows an embodiment of a transposition scheme which comprises no frequency shifting for signal components of the first source stack 22 to the destination stack 32. The second source stack 23, as in FIG. 3, is again a compressive frequency transposition.

In FIG. 5, a graph is shown of a further embodiment of the recently proposed frequency transposition scheme, wherein the spectral energy in the lower source region 21 is copied (i.e. transposed) to the lower destination region 31 up to the lower cut-off frequency FC (via a one-to-one mapping). Furthermore, the spectral energy of a first source stack 22, which starts at the lower cut-off frequency FC and ends at a upper cut-off frequency F_{HL} (i.e. being the lowest frequency of the second source stack 23), is copied to a destination stack 32 (again one-to-one mapping). While the upper cut-off frequency F_{HL} is ideally envisaged to be the edge of the aidable region of hearing for the hearing device user (it is noted that the upper cut-off frequency F_{HL} could also be higher or lower than the edge of the aidable region of hearing), up to which upper cut-off frequency F_{HL} the auditory expectations of the hearing device user need to be respected, the lower cut-off frequency FC is determined by the following equation:

$${F}_{k} = \frac{{C}_{R} \cdot FC - {F}_{HL}}{{C}_{R} - 1} ,$$

wherein
C_{R} is a compression ratio in the second source stack 23 of the two source stacks 22 and 23;
FC corresponds to the lower cut-off frequency defined between a lower source region 21 and a first source stack 22;
F_{HL} corresponds to the upper cut-off frequency being the lowest frequency of the second source stack 23; and
Fₖ corresponds to a start frequency being defined as point of intersection between a one-to-one mapping of frequency components in the lower source region 21 and an extension of the compressive mapping of the second source stack 23.

The determination of the optimal values of parameters in the above equation for a given hearing loss could be based on audiological experiments that are described, for example, in a publication entitled “Modified Verification Approaches for Frequency Lowering Devices” by Danielle Glista & Susan Scollie (National Centre for Audiology, the University of Western Ontario, Sep. 11, 2009). This publication can be retrieved from the internet under http://www.audiologyonline.com/articles/article_detail.asp?artic le_id=2301.

In this frequency transposition scheme the compression does not start at the lower cut-off frequency FC but at the upper cut-off frequency F_{HL}. The compression ends at the upper frequency Fᵤ, above which no relevant information is expected. The second source stack 23—defined between the upper cut-off frequency F_{HL} and the upper frequency Fᵤ—is transposed as well to the destination stack 32, in which a replacement and/or superposition of spectral energy of the first source stack 22 and/or the second source stack 23 takes place. For example, a biased peak picking algorithm or a weighting function w with subsequent superposition is applied to emphasize relevant spectral information in the second source stack 23 or in the first source stack 22.

A biased peak picking method is used to respect the auditory expectation of the hearing device user and is achieved by using an appropriate spectral weighting function.

The weighting function w (also referred to as expectation bias function) is used to adaptively choose different parts of the input spectrum—e.g. the first source stack 22 or the second source stack 23 (cf. FIG. 5)—to transpose to the destination stack 32. The spectral energy magnitudes are multiplied by the weights of the weighting function w (either a continuous frequency-dependent function or discrete weighting factors Wᵢ) and this weighted spectrum can be used by a frequency transposition scheme for further processing.

The weighting function w weights the input spectrum in such a way that the already available low frequency information is given more significance. If a frequency transposition scheme then selects the most important information from a given source region 20 to be transposed to a destination region 30, auditory expectations are respected more and information is transposed only if it is considerably significant in comparison to what is already accessible to the hearing impaired user in the lower source region 21 or the lower destination region 31.

An advantage of using a weighting function w is that an adaptive lowering can be accomplished without any explicit real time detection of phonemes themselves. This is accomplished by a careful choice of weights and by exploiting the fact that fricatives have proportionally much larger energy in the higher frequencies compared to vowels. This keeps the vowels from getting distorted while still lowering high frequency information in fricatives.

The frequency transposition scheme according to this embodiment ensures two things. First, it separates the second source stack 23 from the first source stack 22 in the frequency transposition context. The second difference is that the final output of the frequency transposition scheme in the destination stack 32 is chosen with a biased peak picking algorithm between the spectral energies of the first source stack 22 and the second source stack 23. This results in the final input/output curve becoming signal dependent unlike in the previously known frequency transposition scheme shown in FIG. 2, where a non-linear monotonic relationship between the input frequency fᵢₙ and the output frequency fₒᵤₜ is implemented.

The separation of the second source stack 23 and the destination stack 32 in the compression scheme, together with a biased peak picking allows for transposing energies only when they are significant compared to what is already there in the first source stack 22. This leaves the already audible harmonic structure of the vowels intact while still transposing fricatives and other phonemes dominated by high frequency energies. As the harmonic relationship of the notes of western instrumental music is similar to vowels, this frequency transposition scheme also distorts music less in comparison to the known techniques.

FIG. 6a) shows a block diagram of an embodiment of a fitting apparatus FA according to the present invention for adjusting a hearing device HD comprising frequency transposition means 6 to hearing preferences of a user of said hearing device HD. The fitting apparatus FA comprises at least two control elements 7, i.e. perception controls H, D, V, A, each associated with adjusting a different auditory perceptive dimension. The fitting apparatus FA further comprises determination means 8 adapted to automatically determine settings of the frequency modification parameters of the frequency transposition means 6 based on settings of the perception control elements H, D, V, A. The determination means 8 may comprises a lookup table 9 for performing a mapping from the perception control settings H, D, V, A to corresponding frequency modification parameters C_{R}, Fₖ, F_{HL}, W for the frequency transposition means 6. Alternatively (or additionally), the determination means 8 may comprise an interpolator 14 for interpolating between predetermined values of the parameter set C_{R}, Fₖ, F_{HL}, W associated with extreme settings of the control settings H, D, V, A, i.e. settings of C_{R}, Fₖ, F_{HL}, W for H, D, V and A either being 0 (minimum) or 100% (maximum). Alternatively (or further additionally), the determination means 8 may comprise a weighting means 15 for weighting pre-determined settings C_{R}, Fₖ, F_{HL}, W associated with certain predefined values of the settings H, D, V, A, where the weighting is dependent on the current settings of the perception controls 7. The frequency modification parameters C_{R}, Fₖ, F_{HL}, W are then transferred to the frequency transposition means 6 within the hearing device HD via the communication link L, e.g. a wireless link.

FIG. 6b) shows a block diagram of an alternative embodiment of a fitting apparatus FA according to the present invention. The fitting apparatus FA comprises a control element 7′, i.e. a transposition control, for adjusting one of the frequency modification parameters C_{R}, Fₖ, F_{HL}, W used to configure the frequency transposition means 6. The fitting apparatus FA further comprises a prediction means 16 for automatically determining a qualitative prediction value for each auditory perceptive dimension based on the setting of the transposition control element 7′. Moreover, the fitting apparatus FA further comprises a display 18 for presenting the qualitative prediction value for each of the auditory perceptive dimensions to the fitter. Based on the feedback provided by the fitting apparatus FA in form of the presented impact the setting of the transposition control element 7′ has on the different auditory perceptive dimensions, the fitter can make further adjustments to the transposition control element 7′ in order to modify the resulting effect on the different auditory perceptive dimensions. Additional transposition control element 7″ may also be employed to adjust other ones of the frequency modification parameters C_{R}, Fₖ, F_{HL}, W. Their effect on the various auditory perceptive dimensions can then be shown in combination with that due to the setting of the other transposition control element 7′ via the display 18. The prediction means 16 may comprise one or more estimators 17. The one or more estimators 17 determine the qualitative prediction value associated with each auditory perceptive dimension by for instance mathematically applying a test signal (e.g. a speech sample or music) to a model d (of the transfer function) of the hearing device HD, especially the frequency transposition function configured by the frequency modification parameters, which is set by the transposition control element 7′. The output signal from the model d is then further processed, e.g. according to the audiogram d′ of the hearing impaired user of the hearing device HD, thus yielding a signal as perceived by the user (i.e. a modelled perceived signal). Subsequently, the qualitative prediction value associated with each auditory perceptive dimension can be derived by an analysis of the modelled perceived signal or a difference between the modelled perceived signal and the test signal. Alternatively, such qualitative prediction values may also be derived from data stored in a database 19 comprising results of (qualitative and/or quantitative) assessments, e.g. of auditory performance tests, performed by hearing impaired persons having various degrees of hearing impairment, the assessment results being provided from tests using various hearing devices with different settings, especially of the frequency modification parameters C_{R}, Fₖ, F_{HL}, W.

According to the fitting method of the present invention, first the following non-adjustable parameters are determined:
frequency above which amplification is not sufficient, which is a function of the audiogram d′, and
maximum aided gain, which is a function of the hearing aid (model d) and the acoustical coupling d″ of the hearing aid to the ear of the user.

Then, the fitter adjusts at least two of the following perception based macro controls:
“harmonics protection” H;
“distinction” D;

“vowel information protection” V; and
“audibility” A,
   thus specifying in different auditory perception domains the performance that the hearing device HD is required to deliver in order to provide the desired perception of sounds as needed by the user based on the user's specific hearing impairment.

These perception based macro controls automatically control the following four parameters of the frequency transposition means 6:
compression coefficient C_{R};
lower cut-off frequency Fₖ;
upper cut-off frequency F_{HL}; and
weighting original/lowered signal W.

The mapping from the control settings H, D, V, A to the set of frequency modification parameters C_{R}, Fₖ, F_{HL}, W may be achieved by means of a lookup table 9. Alternatively, the parameter set C_{R}, Fₖ, F_{HL}, W can be determined by interpolating between predetermined values of the parameter set C_{R}, Fₖ, F_{HL}, W associates with extreme settings of the control settings H, D, V, A, i.e. settings of C_{R}, Fₖ, F_{HL}, W for H, D, V and A either being 0 (minimum) or 100% (maximum). Moreover, weights can be applied to pre-determined settings C_{R}, Fₖ, F_{HL}, W associated with certain predefined values of the settings H, D, V, A, where the weights are dependent on the current settings of the perception based macro controls.

In the following examples, the frequency above which amplification is not sufficient is assumed to be 2 kHz.

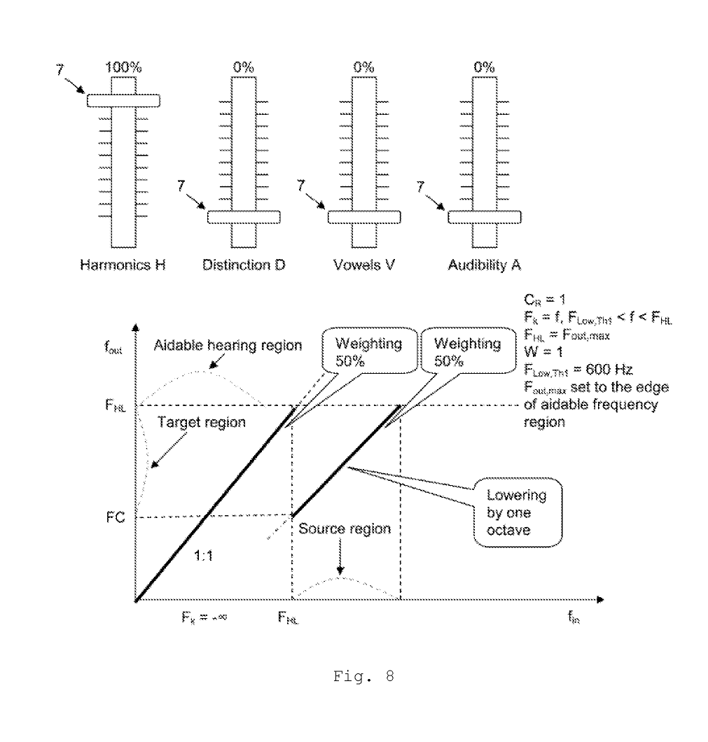

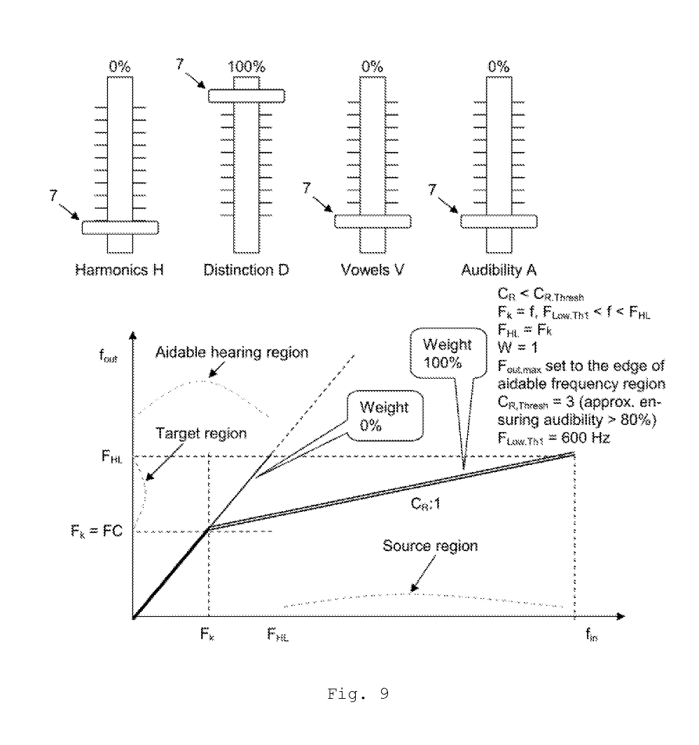

FIG. 7 shows a graph illustrating a first frequency transposition scheme with certain mixed settings of the perception based controls. The frequency modification parameters C_{R}, Fₖ, F_{HL} & W can for instance be determined by interpolating between the extreme settings shown in FIGS. 8 to 11, dependent on the current settings of the perception based macro controls.

FIG. 8 shows a further graph illustrating a second frequency transposition scheme employing perception based controls with settings directed to maximising protection of harmonics. The perceptive dimension “harmonics protection” indicates how well harmonic relationships within the signal are preserved. This means, that for example an octave remains an octave and a third remains a third after processing. There are various hearing tests relating to harmonics, in particular known from musical talent assessment. In one, pairs of tones with different pitch are processed and presented to an individual. The individual is then asked to estimate the pitch difference. A frequency transposition configuration scores well in the dimension “harmonics protection” if source and target frequencies differ exactly by an octave or a multiple of an octave. Frequency compression is detrimental to the harmonics, while frequency stacking may be tolerable.

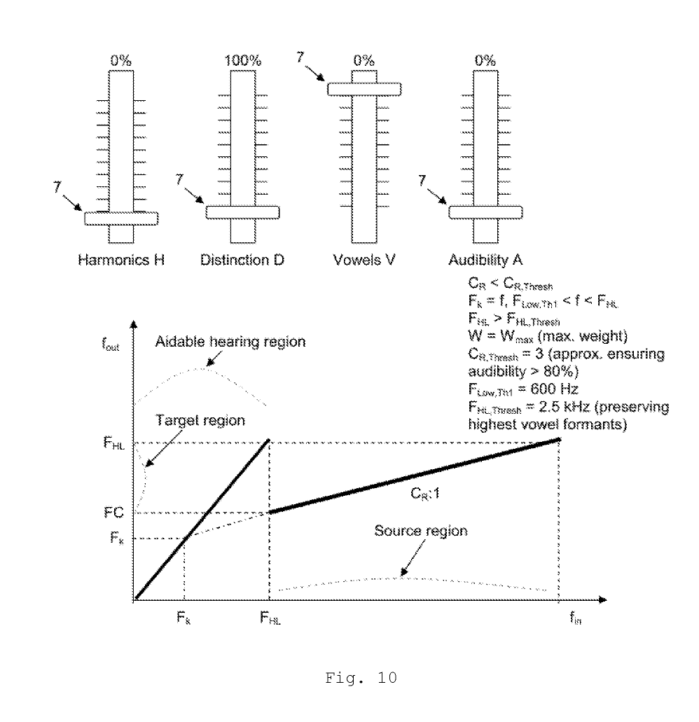

FIG. 9 shows a further graph illustrating a third frequency transposition scheme employing perception based controls with settings directed to maximising distinction. The perceptive dimension “distinction” is very common in the field of speech hearing tests. Phonemes such as “ABA” and “AFA” are presented to the individual. The individual does not have recognize if “ASA” or “AFA” was presented, but instead only indicate if a set consisted of equal or different phonemes. Some frequency transposition schemes are very detrimental to distinction. The “s” being in the high frequencies may be shifted downward such that it sounds like an “f”. Even though the audibility may be improved by this, the individual may not be able to distinguish “s” and “f” any more. Frequency stacking is generally detrimental to distinction, while a moderate frequency compression may be tolerable.

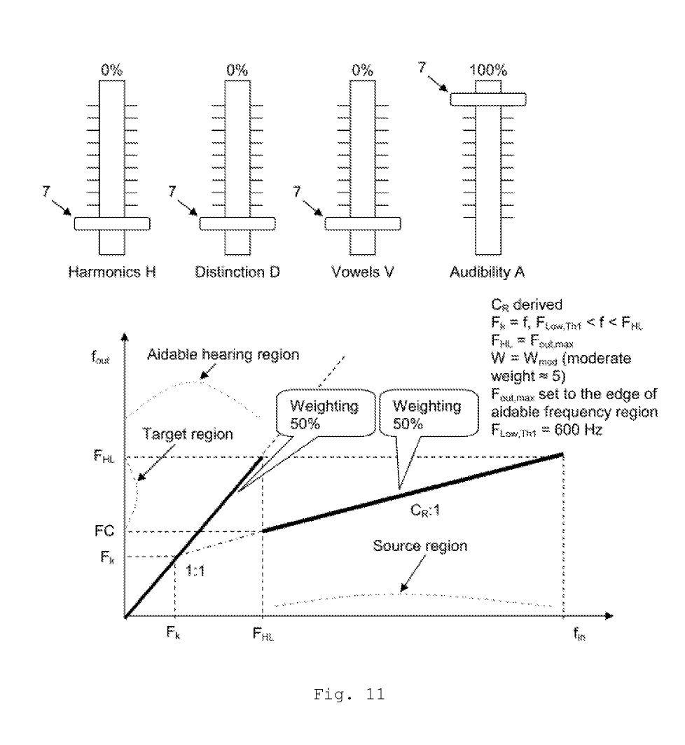

FIG. 10 shows a further graph illustrating a fourth frequency transposition scheme employing perception based controls with settings directed to maximising vowel preserving. The perceptive dimension “vowel information protection” regards mainly the low frequencies. A corresponding hearing test may be a vowel recognition or vowel distinction test. For maximum “vowel information protection” it is best not to apply any frequency transposition having the low frequencies as source region. Frequency stacking with low frequencies as target region may be tolerable.

Finally, FIG. 11 shows a further graph illustrating a fifth frequency transposition scheme employing perception based controls with settings directed to maximising audibility. The perceptive dimension “audibility”—also referred to as “detection”—is the one measured by the most basic hearing tests. For example, in a conventional pure tone audiometry the individual simply has to indicate if a sound was perceived. In an audibility test, the individual does not have to indicate which sound was perceived. In configuring frequency transposition there is usually a trade-off between distinction and audibility. By transposing all sounds to the frequency range where the individual hears best audibility is maximized but distinction and detection is compromised.

The perceptive dimension “recognition” is one commonly measured in speech tests. For example a phoneme such as “ABA” or “AFA” is presented to an individual and the individual has to indicate which one it was. In a recognition test, it is not sufficient if the individual indicates the pure fact that a phoneme was perceived or that it was different from the last one. Generally frequency stacking and strong frequency compression is detrimental to recognition. However, since audibility is a prerequisite for recognition, a moderate compression may even be necessary for recognition. Further, it is to be noted, that recognition test results may depend on learning effects. Since hearing aid fitting is targeted to long term performance, it is best to define the dimension based on a recognition test applied after the individual had time to get accustomed to the new processing.

There are also further perceptive dimensions for which no performance tests exist, for example “naturalness”, “familiarity” and “comfort”. For these dimensions there are only subjective tests, which for instance employ a rating scale. Therefore these further perceptive dimensions cannot be utilised in connection with the present invention. However, if a control element such as a slider associated with a perceptive dimension “familiarity” were to be used, a high setting value thereof could for instance adjust the fitting such that it more closely resembles a previous fitting with which the user is familiar from prior experience.

What is claimed is:

1. A method for adjusting a hearing device (HD) comprising frequency transposition means (6) to hearing preferences of a user of said hearing device (HD), said frequency transposition means (6) being configurable by at least two frequency modification parameters (C_{R}, Fₖ, F_{HL}, W), said method comprising the steps of:
a1) manually adjusting at least two control elements (7) each associated with a different one of at least two auditory perceptive dimensions (H, D, V, A);
b1) automatically setting said at least two frequency modification parameters (C_{R}, Fₖ, F_{HL}, W) based on said adjusting of said at least two control elements (7).

2. A method for adjusting a hearing device (HD) comprising frequency transposition means (6) to hearing preferences of a user of said hearing device (HD), said frequency transposition means (6) being configurable by at least two frequency modification parameters (C_{R}, Fₖ, F_{HL}, W), said method comprising the steps of:
a2) manually adjusting at least one control element (7′, 7″) associated with one of said at least two frequency modification parameters (C_{R}, Fₖ, F_{HL}, W);
b2) determining based on said adjusting a qualitative prediction value for each of at least two auditory perceptive dimensions (H, D, V, A).

3. Method according to claim 2, further comprising the step of displaying said qualitative prediction value for at least one of, preferably for each of, said at least two auditory perceptive dimensions (H, D, V, A).

4. Method according to claim 1, wherein
each of said at least two auditory perceptive dimensions (H, D, V, A) is a dimension in which an auditory performance of said user can be influenced by changing said at least two frequency modification parameters (C_{R}, Fₖ, F_{HL}, W).

5. Method according to claim 1, wherein
each of said at least two auditory perceptive dimensions (H, D, V, A) is a dimension for which said user's auditory perception can be assessed by means of an auditory performance test, an auditory performance test being a test which allows to compare the auditory performance of two individuals or of two different aided conditions for the same individual.

6. The method according to claim 1, further comprising the step of performing an auditory performance test to assess the auditory performance of the user for at least one of the at least two auditory perceptive dimensions (H, D, V, A), and subsequently performing or repeating steps a1) and b1), step a1) then being based on the outcome of the auditory performance test.

7. Method according to claim 1, wherein said auditory perceptive dimension is selected from a group comprising at least two of:
harmonics protection (H);
distinction (D);
audibility (A);
recognition;
vowel information protection (V).

8. Method according to claim 7, wherein said audibility (A) pertains to one or more of:
general audibility;
phoneme audibility;
vowel audibility;
consonant audibility, in particular audibility of fricatives such as “s” and “f”;
tone audibility.

9. Method according to claim 7, wherein said distinction (D) pertains to one or more of:
general distinction;
phoneme distinction;
vowel distinction;
consonant distinction;
word distinction;
musical tone distinction;
musical interval or chord distinction;
timbre distinction.

10. Method claim 7, wherein said recognition pertains to one or more of:
general recognition;
phoneme recognition;
vowel recognition;
consonant recognition;
word recognition;
speech recognition;
musical tone recognition;
musical interval or chord recognition;
timbre recognition.

11. Method according to claim 7, wherein said group comprises at least a vowel dimension, in particular one or more of:
a general vowel dimension;
a vowel audibility dimension;
a vowel distinction dimension;
a vowel recognition dimension.

12. Method according to claim 1, wherein said frequency modification parameters comprise at least two of the following:
compression ratio (C_{R});
lower cut-off frequency (Fₖ);
upper cut-off frequency (F_{HL});
frequency weighting factor (W) or frequency weighting function (w).

13. Method according to claim 12, wherein the lower cut-off frequency (Fₖ) is 1′500 Hz or less and/or the upper cut-off frequency (F_{HL}) is 2 kHz or less.

14. Method according to claim 1, wherein settings of said at least two frequency modification parameters (C_{R}, Fₖ, F_{HL}, W) are derived from settings of said at least two control elements by means of a look-up table (9).

15. Method according to claim 1, wherein settings of said at least two frequency modification parameters (C_{R}, Fₖ, F_{HL}, W) are derived from settings of said at least two control elements (7) by means of interpolation, in particular linear interpolation, particularly between settings of said at least two frequency modification parameters (C_{R}, Fₖ, F_{HL}, W) corresponding to extreme settings for each of said at least two control elements (7), in particular maximum and/or minimum settings of each of said at least two control elements (7).

16. Method according to claim 1, wherein settings of said at least two frequency modification parameters (C_{R}, Fₖ, F_{HL}, W) are derived from settings of said at least two control elements (7) by means of a weighted sum, the weighting being dependent on the setting of each of said at least two control elements (7).

17. An apparatus for adjusting a hearing device (HD) comprising frequency transposition means (6) to hearing preferences of a user of said hearing device (HD), said frequency transposition means (6) being configurable by at least two frequency modification parameters (C_{R}, Fₖ, F_{HL}, W), said apparatus comprising:
at least two control elements (7), in particular manually adjustable control elements, each associated with adjusting a different one of at least two auditory perceptive dimensions (H, D, V, A);
determination means (8) adapted to automatically determine settings of said at least two frequency modification parameters (C_{R}, Fₖ, F_{HL}, W) based on settings of said at least two control elements (7) corresponding to target values within the associated auditory perceptive dimension (H, D, V, A).

18. An apparatus for adjusting a hearing device (HD) comprising frequency transposition means (6) to hearing preferences of a user of said hearing device (HD), said frequency transposition means (6) being configurable by at least two frequency modification parameters (C_{R}, Fₖ, F_{HL}, W), said apparatus comprising:
at least one control element (7′, 7″), in particular a manually adjustable control element, associated with one of said at least two frequency modification parameters (C_{R}, Fₖ, F_{HL}, W);
prediction means (16) for automatically determining a qualitative prediction value for each of at least two auditory perceptive dimensions (H, D, V, A) based on a setting of said at least one control element (7′, 7″);
presentation means (18) for displaying said qualitative prediction value for each of said at least two auditory perceptive dimensions (H, D, V, A).

19. Apparatus according to claim 17, wherein each of said at least two auditory perceptive dimensions (H, D, V, A) is a dimension in which an auditory performance of said user can be influenced by changing said at least two frequency modification parameters (C_{R}, Fₖ, F_{HL}, W).

20. Apparatus according to claim 17, wherein each of said at least two auditory perceptive dimensions (H, D, V, A) is a dimension for which said user's auditory perception can be assessed by means of an auditory performance test, an auditory performance test being a test which allows to compare the auditory performance of two individuals or of two different aided conditions for the same individual.

21. Apparatus according to claim 17, wherein said perceptive dimension is selected from a group comprising at least two of:
harmonics protection (H);
distinction (D);
audibility (A);
recognition;
vowel information protection (V).

22. Apparatus according to claim 21, wherein said audibility (A) pertains to one or more of:
general audibility;
phoneme audibility;
vowel audibility;
consonant audibility, in particular audibility of fricatives such as “s” and “f”;
tone audibility.

23. Apparatus according to claim 21, wherein
said distinction (D) pertains to one or more of:
general distinction;
phoneme distinction;
vowel distinction;
consonant distinction;
word distinction;
musical tone distinction;
musical interval or chord distinction;
timbre distinction.

24. Apparatus of claim 21, wherein said recognition pertains to one or more of:
general recognition;
phoneme recognition;
vowel recognition;
consonant recognition;
word recognition;
speech recognition;
musical tone recognition;
musical interval or chord recognition;
timbre recognition.

25. Apparatus according to claim 21, wherein said group comprises at least a vowel dimension, in particular one or more of:
a general vowel dimension;
a vowel audibility dimension;
a vowel distinction dimension;
a vowel recognition dimension.

25. Apparatus according to claim 17, wherein said frequency modification parameters comprise at least two of the following:
compression ratio (C_{R});
lower cut-off frequency (Fₖ);
upper cut-off frequency (F_{HL});
frequency weighting factor (W) or frequency weighting function (w).

26. Apparatus according to claim 25, wherein the lower cut-off frequency (Fₖ) is 1′500 Hz or less and/or the upper cut-off frequency (F_{HL}) is 2 kHz or less.

27. Apparatus according to claim 17, further comprising a look-up table (9) configured to derive settings of said at least two frequency modification parameters (C_{R}, Fₖ, F_{HL}, W) from settings of said at least two control elements (7).

28. Apparatus according to claim 17, further comprising interpolation means (14) configured to derive settings of said at least two frequency modification parameters (C_{R}, Fₖ, F_{HL}, W) from settings of said at least two control elements (7), in particular configured to perform linear interpolation, particularly configured to perform interpolation between settings of said at least two frequency modification parameters (C_{R}, Fₖ, F_{HL}, W) corresponding to extreme settings for each of said at least two control elements (7), in particular maximum and/or minimum settings of each of said at least two control elements (7).

29. Apparatus according to claim 17, further comprising weighting means (15) for providing weighted sums configured to derive settings of said at least two frequency modification parameters (C_{R}, Fₖ, F_{HL}, W) from settings of said at least two control elements (7), the weighting being dependent on the setting of each of said at least two control elements (7).
